(19) United States
(12) Patent Application Publication
(10) Pub. No.: US 2013/0238982 A1
(43) Pub. Date: Sep. 12, 2013

(54) METHODS AND APPARATUS FOR EDITING AN APPLICATION WEBPAGE

(71) Applicants: Yana Gong, Shenzhen (CN); Fei Huang, Shenzhen (CN); Danni Lin, Shenzhen (CN); Junhao Fan, Shenzhen (CN); Guanglue Huang, Shenzhen (CN); Fang Ye, Shenzhen (CN); Xiaopeng Shen, Shenzhen (CN); Guorui Li, Shenzhen (CN); Jian Chen, Shenzhen (CN)

(72) Inventors: Yana Gong, Shenzhen (CN); Fei Huang, Shenzhen (CN); Danni Lin, Shenzhen (CN); Junhao Fan, Shenzhen (CN); Guanglue Huang, Shenzhen (CN); Fang Ye, Shenzhen (CN); Xiaopeng Shen, Shenzhen (CN); Guorui Li, Shenzhen (CN); Jian Chen, Shenzhen (CN)

(73) Assignee: TENCENT TECHNOLOGY (SHENZHEN) COMPANY LIMITED, SHENZHEN (CN)

(21) Appl. No.: 13/885,432

(22) PCT Filed: Jul. 14, 2011
(86) PCT No.: PCT/CN11/77156

§ 371 Date: May 15, 2013

(30) Foreign Application Priority Data
Nov. 23, 2010 (CN) 201010567709.1

(51) Int. Cl. G06F 17/22

(52) U.S. Cl. CPC G06F 17/2247
USPC 715/234

(57) ABSTRACT

A method and apparatus for editing an application webpage, including prestoring information of a function and configuration data corresponding to the function; generating a webpage design, monitoring that shortcut area edit is triggered, obtaining shortcut area information inputted by a user, obtaining size of a shortcut area and position information corresponding to the shortcut area according to the shortcut area information; receiving function data inputted by the user according to preconfigured configuration data corresponding to the selected function, encapsulating the function data, the size of the shortcut area and the position information corresponding to the shortcut area into a data file; loading a running environment of the data file, creating a webpage shortcut area according to the size of the shortcut area and the position information corresponding to the shortcut area included in the data file; and extracting the function data in the data file, generating page function codes corresponding to the function, filling the webpage shortcut area corresponding to the function with the page function codes to form an application webpage for displaying.

The present Application claims priority to a Chinese Patent Application 201010567709.1, entitled “Method and Apparatus for Editing an Application Webpage”, filed on Nov. 23, 2010. The disclosures of the application No. 201010567709.1 are incorporated herein by reference.

### FIELD OF THE INVENTION

The present invention relates to webpage editing technologies, and more particularly, to a method and apparatus for editing an application webpage.

### BACKGROUND OF THE INVENTION

With the development of computer networks and communication technologies, it has become an essential part of user's daily life to obtain related information through internet. Besides, a user (e.g., a product operator or a service operator) may also release his own shared information or demands to internet through application webpage editing of webpage-related technicians. Thus, it can not only greatly enhance information exchange among internet users, but also effectively improve promotion and use of applications.

In conventional systems, two technical solutions shown as follows are generally used by the webpage-related technicians to perform application webpage edit and webpage release, which are described hereinafter.

Technical solution one relates to processes of an application such as page design, page reconstruction, page development, page test, page release, and so on. According to requirements of the operator or the user, webpage designers (page reconstruction engineers) perform webpage style development to a function of an application such as an application (a subject application) in some shopping or travel websites that has fixed functionalities and an undiversified mode, and needs to be operated in long-term and be quickly updated, e.g., a gifting application, a video playing application, etc. For example, a draft design and cut maps provided by the user are analyzed, and a Hyper Text Mark-up Language (HTML) script program is developed; during this process, it may approximately take, for one subject, 1.5 days per person plus the joint-debugging time. And then according to a specific subject function and the developed webpage style, WEB front-end development engineers perform webpage development, develop codes corresponding to function data obtained during the webpage development and the codes are filed to generate an application webpage, it may approximately take 1.5 days per person for each subject. At last, WEB test engineers design and implement test examples, test, verify and release the subject function of the application webpage, it may approximately take 1 day per person for each subject.

As can be seen that, when the process for editing and releasing the application webpage is implemented according to technical solution one, it is necessary to involve product staffs, engineers and so on, so that costs for communication and joint-debugging are high and the consumed time is long. Thus, based on the above deficiencies, an improved template technical solution is proposed, in which the developers perform the webpage style development to some webpages with a fixed structure, a more standard webpage template is configured by fixing the number of functions in each page and a position where each function occurs; subsequently, the application webpage may be represented by dynamically loading a corresponding background picture in each position where each corresponding function occurs, configuring function data of the function corresponding to the background picture and automatically generating codes corresponding to the function data, etc., so that the costs and the consumed time is greatly reduced. However, the number of each function and the position where each function occurs is fixed, e.g., only several “gifting” function buttons are allowed and the positions of the function buttons are fixed. Thus, in practice, only an identifier (ID) of a gifted article can be changed, the number of the “gifting” function buttons cannot be increased in the webpage template, the positions of the function buttons cannot be changed either, and moreover, the webpage structure cannot be changed dynamically; thus, the webpage structure is fixed and the design style is undiversified, which could not meet requirements of diversification and quick update of a subject application, and it is not conductive to the creation and diversified design styles of designers, efficiency of application webpage edit is low. Furthermore, when the number of the functions is changed, it is necessary to re-configure the webpage template, so that the codes of the webpage template solution are redundant, and the code reuse rate is low.

### SUMMARY OF THE INVENTION

In view of the above, examples of the present invention provide a method for editing an application webpage, which can satisfy a quick update requirement of a subject application and improve efficiency of application webpage edit.

Examples of the present invention also provide an apparatus for editing an application webpage, which can satisfy a quick update requirement of a subject application and improve efficiency of application webpage edit.

To achieve the above objective, an example of the present invention provides a method for editing an application webpage, including:

prestoring information of a function and configuration data corresponding to the function;

generating a webpage design, monitoring that shortcut area edit is triggered, obtaining shortcut area information inputted by a user, obtaining size of a shortcut area and position information corresponding to the shortcut area according to the shortcut area information;

receiving function data inputted by the user according to preconfigured configuration data corresponding to the function, encapsulating the function data, the size of the shortcut area and the position information corresponding to the shortcut area into a data file;

loading a running environment of the data file, creating a webpage shortcut area according to the size of the shortcut area and the position information corresponding to the shortcut area included in the data file; and

extracting the function data in the data file, generating page function codes corresponding to the function, filling the webpage shortcut area corresponding to the function with the page function codes to form an application webpage for displaying.

The function includes but is not limited to a gifting function and a video playing function.

Configuration data corresponding to the gifting function includes configuring information about an ID of a gifted article, configuration data corresponding to the video playing function includes configuring information about a video ID, and/or information about whether to play automatically, and/or information about a Uniform Resource Locator (URL) of a video cover picture.

The method further including:

when it is monitored that a user mouse resides in the shortcut area created in the application webpage, triggering the configured function.

An example of the present invention provides an apparatus for editing an application webpage, including a page content editing unit and a page content parsing unit, wherein,

the page content editing unit is to, after a webpage design is generated and it is monitored that shortcut area edit is triggered, obtain shortcut area information inputted by a user, calculate size of a shortcut area and position information corresponding to the shortcut area according to the shortcut area information; receive function data inputted by the user according to preconfigured configuration data corresponding to a selected function; encapsulate the function data, the size of the shortcut area and the position information corresponding to the shortcut area into a data file; and output to the page content parsing unit the data file; and

the page content parsing unit is to receive the data file, load a running environment of the data file, create the webpage shortcut area according to the shortcut area information included in the data file, extract the function data in the data file, generate page function codes corresponding to the function, fill the webpage shortcut area corresponding to the function with the page function codes to form an application webpage for displaying.

The page content editing unit comprises a function editing module, a shortcut area editing module, a shortcut area displaying module, an encapsulation processing module and a storing module, wherein,

the function editing module is to prestore information of the function and the configuration data corresponding to the function, receive a trigger signal outputted by the shortcut area editing module, and output to the shortcut area displaying module the stored information of the function and the stored configuration data corresponding to the function;

the shortcut area editing module is to, after the shortcut area edit is triggered, monitor the shortcut area information inputted by the user, calculate the size of the shortcut area and the position information corresponding to the shortcut area according to the shortcut area information, output the trigger signal to the function editing module, receive the function data outputted by the shortcut area displaying module, and output to the storing module the function data, the size of the shortcut area and the position information corresponding to the shortcut area;

the shortcut area displaying module is to receive the information of the function outputted by the function editing module to show to the user, receive the function data inputted by the user according to the configuration data corresponding to the selected function, and output to the shortcut area editing module the function data;

the storing module is to receive information outputted by the shortcut area editing module for storage; and

the encapsulation processing module is to encapsulate the information stored in the storing module into the data file, and output the data file to the page content parsing unit.

The shortcut area editing module is further to output to the shortcut area displaying module the size of the shortcut area and the position information corresponding to the shortcut area which is obtained through calculation, receive size of the shortcut area and position information corresponding to the shortcut area returned from the shortcut area displaying module, update the size of the shortcut area and the position information corresponding to the shortcut area which is obtained through the calculation; and

the shortcut area editing module is further to display the received size of the shortcut area and the received position information corresponding to the shortcut area to show to the user, and output to the shortcut area editing module size of the shortcut area and position information corresponding to the shortcut area which is ultimately determined by the user.

The page content parsing unit comprises a function filling module, a shortcut area filling module and a container page module, wherein,

the container page module is to receive the data file and load the running environment of the data file;

the function filling module is to receive the data file, extract the function data from the data file, generate the page function codes corresponding to the function, and output to the shortcut area filling module the page function codes; and

the shortcut area filling module is to create the webpage shortcut area according to the shortcut area information included in the data file, fill the webpage shortcut area corresponding to the function with the page function codes outputted by the function filling module to form the application webpage.

As can be seen from the above technical solution, examples of the present invention provides a method and apparatus for editing an application webpage, including prestoring information of a function and configuration data corresponding to the function; generating a webpage design, monitoring that shortcut area edit is triggered, obtaining shortcut area information inputted by a user, obtaining size of a shortcut area and position information corresponding to the shortcut area according to the shortcut area information; receiving function data inputted by the user according to preconfigured configuration data corresponding to the selected function, encapsulating the function data, the size of the shortcut area and the position information corresponding to the shortcut area into a data file; loading a running environment of the data file, creating a webpage shortcut area according to the size of the shortcut area and the position information corresponding to the shortcut area included in the data file; and extracting the function data in the data file, generating page function codes corresponding to the function, filling the webpage shortcut area corresponding to the function with the page function codes to form an application webpage for displaying. Thus, the number of functions can be dynamically configured and positions of the functions can also be dynamically adjusted, so that a webpage structure can be dynamically adjusted, a quick update requirement of a subject application is satisfied, efficiency of application webpage edit is improved.

### BRIEF DESCRIPTION OF DRAWINGS

FIG. 1 is a flowchart illustrating a method for editing an application webpage in accordance with an example of the present invention.

FIG. 2 is a schematic diagram illustrating a structure of an apparatus for editing an application webpage in accordance with an example of the present invention.

FIG. 3 is a schematic diagram illustrating another structure of a page content parsing unit in accordance with an example of the present invention.

FIG. 4 is a detail flowchart illustrating a method for editing an application webpage in accordance with an example of the present invention.

FIG. 5 is a schematic diagram illustrating an interface of an application webpage edit platform in accordance with an example of the present invention.

### DETAILED DESCRIPTION OF THE INVENTION

The present invention is hereinafter described in detail with reference to accompanying drawings and examples, so as to make technical solution and merits of the present invention more apparent.

In examples of the present invention, information of a function and configuration data corresponding to the function is prestored; a user-defined page structure is adopted; the size of each shortcut area and position information corresponding to each shortcut area in a user-defined page is obtained; the configuration data corresponding to the function of the shortcut area is edited to obtain corresponding function data; page function codes corresponding to the function are generated and filled to a webpage shortcut area created according to the size of the shortcut area and the position information corresponding to the shortcut area. Thus, a corresponding subject plan is completed.

FIG. 1 is a flowchart illustrating a method for editing an application webpage in accordance with an example of the present invention. As shown in FIG. 1, the method includes blocks as follows.

In block 101, information of a function and configuration data corresponding to the function is prestored.

In the block, the configuration data corresponding to the function includes data configuration information required by the function, i.e., configuration information associated with a particular function such as gifting, video playing, etc., which may be determined according to actual requirements,. For example, for the gifting function, the preconfigured configuration data includes configuring information about an ID of a gifted article; for the video playing function, the configuration data includes configuring information about a video ID, and/or information about whether to play automatically, and/or information about a Uniform Resource Locator (URL) of a video cover picture, etc.

In block 102, a webpage design is generated; it is monitored that shortcut area edit is triggered; shortcut area information inputted by a user is obtained; according to the shortcut area information, size of the shortcut area and position information corresponding to the shortcut area is obtained.

In the block, the webpage design is generated, i.e., the user edits, in a current webpage, a background picture needed to be shown in the application webpage. That the shortcut area information is inputted by the user may be implemented by capturing a mouse event. The size of the shortcut area may be represented by width and height of the shortcut area, the position information corresponding to the shortcut area may be represented by coordinate information. The shortcut area is used to trigger the configured function when it is monitored that a user mouse resides in the edited shortcut area during displaying the application webpage subsequently.

In practice, the size of the shortcut area selected by the user through the mouse may be the same as the size of the background picture, or may be smaller than the background picture.

In block 103, function data is received from the user according to the preconfigured configuration data corresponding to the selected function; the function data, the size of the shortcut area and the position information corresponding to the shortcut area is encapsulated into a data file.

In the block, according to a data format supported by each webpage browser, the function data, the size of the shortcut area and the position information corresponding to the shortcut area is encapsulated into the data file which is supported by the webpage browser.

In block 104, a running environment of the data file is loaded; a webpage shortcut area is created according to the size of the shortcut area and the position information corresponding to the shortcut area included in the data file.

In the block, the created webpage shortcut area is used to trigger the configured function when it is monitored that the user mouse resides in the edited shortcut area after the edited page of the application webpage is released.

In block 105, the function data in the data file is extracted; page function codes corresponding to the function are generated, the webpage shortcut area corresponding to the function is filled with the page function codes to form the application webpage for displaying.

In the block, the data file may include shortcut area function data corresponding to multiple subjects or functions. According to the function data included in the data file, the corresponding page function codes are generated. The page function codes generally refer to all of HTML codes and Javascript (JS) codes related to a special function. For example, for the gifting function, the page function codes include HTML codes of a gifting button and JS codes of an object onclick event of the gifting button. Thus, after the webpage shortcut area corresponding to the function is filled with the corresponding page function codes and the application webpage is released, the configured function may be triggered when it is monitored that the user mouse resides in the edited shortcut area. For example, after the application webpage is released, when the user mouse resides in or clicks a shortcut area where the gifting function locates, related gifting information is prompted, and a linked page of the gifting function is triggered to be entered after the user clicks the shortcut area.

It can be seen from the above that in the method for editing an application webpage in accordance with the example of the present invention, information of a function and configuration data corresponding to the function is prestored; a webpage design is generated; it is monitored that shortcut area edit is triggered; shortcut area information inputted by a user is obtained; according to the shortcut area information, size of the shortcut area and position information corresponding to the shortcut area is obtained; function data is received from the user according to the preconfigured configuration data corresponding to the selected function; the function data, the size of the shortcut area and the position information corresponding to the shortcut area is encapsulated into a data file; a running environment of the data file is loaded; a webpage shortcut area is created according to the size of the shortcut area and the position information corresponding to the shortcut area included in the data file; the function data in the data file is extracted; page function codes corresponding to the function are generated, the webpage shortcut area corresponding to the function is filled with the page function codes to form the application webpage for displaying. Thus, the number of functions may be dynamically configured and positions of the functions may also be dynamically adjusted through self-defining a page structure of an application webpage, editing and updating a function button of a shortcut area in the webpage structure according to actual requirements, so that the webpage structure can be dynamically adjusted, creation and diversified design styles of designers are support, the design styles are diversified, the quick update requirement of a subject application is satisfied, efficiency of application webpage edit is improved. Furthermore, when the number or positions of the functions are changed, the page function codes may be reused so as to improve the code reuse rate of the webpage structure codes.

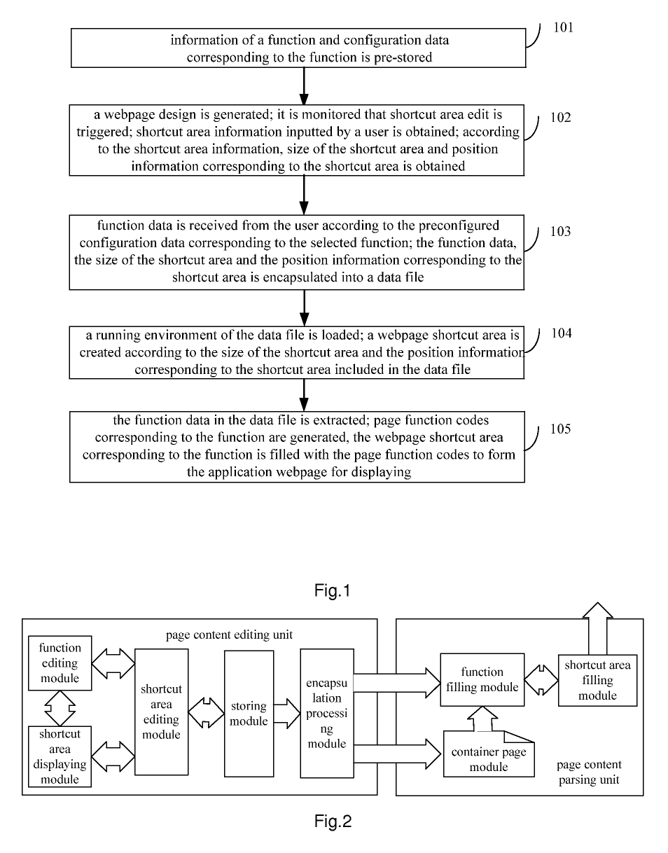

FIG. 2 is a schematic diagram illustrating a structure of an apparatus for editing an application webpage in accordance with an example of the present invention. As shown in FIG. 2, the apparatus includes a page content editing unit and a page content parsing unit.

The page content editing unit is to, after a webpage design is generated and it is monitored that shortcut area edit is triggered, obtain shortcut area information inputted by a user; calculate size of a shortcut area and position information corresponding to the shortcut area according to the shortcut area information; receive function data inputted by the user according to preconfigured configuration data corresponding to a selected function; encapsulate the function data, the size of the shortcut area and the position information corresponding to the shortcut area into a data file; and output to the page content parsing unit the data file.

The page content parsing unit is to receive the data file; load a running environment of the data file; create the webpage shortcut area according to the shortcut area information included in the data file; extract the function data in the data file; generate page function codes corresponding to the function; fill the webpage shortcut area corresponding to the function with the page function codes to form the application webpage for displaying.

In practice, the page content editing unit and the page content parsing unit may be integrated in a same physical device, or may be configured in different physical devices. For example, the page content editing unit is configured in a client, while the page content parsing unit is configured in a server at a network side.

In an example of the present invention, the page content editing unit may include a function editing module, a shortcut area editing module, a shortcut area displaying module, an encapsulation processing module and a storing module.

The function editing module is to prestore function information and the configuration data corresponding to the function, receive a trigger signal outputted by the shortcut area editing module, and output to the shortcut area displaying module the stored function information and the stored configuration data corresponding to the function;

in the example of the present invention, the configuration data includes preconfigured data configuration information required by the function, i.e., configuration information associated with a particular function such as gifting, video playing, etc., which may be determined according to actual requirements. For example, for the gifting function, the preconfigured configuration data includes configuring information about an ID of a gifted article; for the video playing function, the configuration data includes configuring information about a video ID, and/or information about whether to play automatically, and/or information about a URL of a video cover picture, etc.

The shortcut area editing module is to, after the shortcut area edit is triggered, monitor the shortcut area information inputted by the user, calculate the size of the shortcut area and the position information corresponding to the shortcut area according to the shortcut area information, output the trigger signal to the function editing module, receive the function data outputted by the shortcut area displaying module, and output to the storing module the function data, the size of the shortcut area and the position information corresponding to the shortcut area;

in the example of the present invention, the shortcut area edit may be triggered through clicking, by the user, a control button of the shortcut area editing module in a display interface. The user imports a pre-edited webpage design (an edited background picture) to the shortcut area editing module, and the shortcut area is represented as a page DIV element. It is monitored through capturing a mouse event that the user selects the edited shortcut area by the mouse. For example, when the user clicks a left mouse button in a certain area (an area in the background picture), a position of the left mouse button in the area is taken as an initial position of the shortcut area; when it is monitored that the user releases the left mouse button, a position corresponding to the left mouse button in the area is taken as an ending position of the shortcut area. Alternately, when it is monitored that the user releases the left mouse button, confirmation or cancellation information is displayed to the user through the shortcut area displaying module; after the confirmation information which is selected by the user and returned from the shortcut area displaying module is received, the position corresponding to the left mouse button in the area is taken as the ending position of the shortcut area; otherwise, the operation is completed. The size of the edited shortcut area may be calculated according to the information of the initial position and the ending position. Capturing the mouse event and obtaining the information of the initial position and the ending position belongs to the conventional art, and may refer to related technical documents, which is not described repeatedly herein.

In practice, the size of the shortcut area may be represented by width and height of the shortcut area. The position information corresponding to the shortcut area may be represented by coordinate information.

Furthermore, the shortcut area editing module may output to the shortcut area displaying module the size of the shortcut area and the position information corresponding to the shortcut area which is obtained through calculation, receive size of the shortcut area and position information corresponding to the shortcut area returned from the shortcut area displaying module, update the size of the shortcut area and the position information corresponding to the shortcut area which is obtained through the calculation, i.e., output to the storing module the function data, the size of the shortcut area and the position information corresponding to the shortcut area returned from the shortcut area displaying module.

The shortcut area displaying module is to receive the function information outputted by the function editing module to show to the user, receive the function data inputted by the user according to the configuration data corresponding to the selected function, and output the function data to the shortcut area editing module;

in the example of the present invention, the function information may be displayed as a cascading menu, i.e., each function may be redefined by the user according to actual requirements and be displayed as a sub-menu. When the user selects a sub-function, configuration data corresponding to the sub-function is displayed to the user, and the user is requested to input corresponding function data. For example, for the video playing function, the configuration data requests the user to configure and input information about a video ID, information about whether it is required to automatically play, information about a URL of a video cover picture, etc.

As can be seen from the above that when the shortcut area editing module outputs to the shortcut area displaying module the size of the shortcut area and the position information corresponding to the shortcut area which is obtained through calculation, the shortcut area displaying module displays them to the user and outputs to the shortcut area editing module the size of the shortcut area and the position information corresponding to the shortcut area which is ultimately determined by the user. Thus, the user may modify and confirm the selected shortcut area.

The storing module is to receive information outputted by the shortcut area editing module for storage;

in the example of the present invention, the information outputted by the shortcut area editing module is called shortcut area data including the function data and shortcut area information, wherein the shortcut area information is the size of the shortcut area and the position information corresponding to the shortcut area.

The encapsulation processing module is to encapsulate the information stored in the storing module into the data file, and output the data file to the page content parsing unit.

In the example of the present invention, according to a data format supported by each webpage browser, the stored information is encapsulated into the data file supported by the webpage browser. Details may refer to related technical documents, and are not described repeatedly herein.

The page content parsing unit includes a function filling module, a shortcut area filling module and a container page module.

The container page module is to receive the data file and load the running environment of the data file;

in the example of the present invention, the container page module is used to provide an environment for displaying all of the configured shortcut area data.

The function filling module is to receive the data file, extract the function data from the data file, generate the page function codes corresponding to the function and output to the shortcut area filling module;

in the example of the present invention, the data file may include shortcut area data corresponding to multiple subjects or functions. According to the function data included in the data file, the function filling module generates the corresponding page function codes. The page function codes generally refer to all of HTML codes and Javascript codes related to a special function. For example, for the gifting function, the page function codes include HTML codes of a gifting button and JS codes of an object onclick event of the gifting button.

In practice, it may be implemented by use of the conventional art that the page function codes corresponding to the function are generated according to the function data. For example, the corresponding codes are generated through a HTML script program. Details may refer to related technical documents, and are not described repeatedly herein.

The shortcut area filling module is to create the webpage shortcut area according to the shortcut area information included in the data file, fill the webpage shortcut area corresponding to the function with the page function codes outputted by the function filling module to form the application webpage.

In the example of the present invention, the shortcut area filling module dynamically generates the shortcut area in the form of a page DIV element, and then the function filling module is called to fill the shortcut area generated dynamically with the page function codes corresponding to the shortcut area function.

The shortcut area filling module may further output the generated application webpage to a web server for releasing; or, the data file and a container page are released in the web server, and the whole application webpage is dynamically parsed in a client for displaying. It belongs to the conventional art that the page shortcut area corresponding to the function is filled with the page function codes outputted by the function filling module, and is not described repeatedly herein.

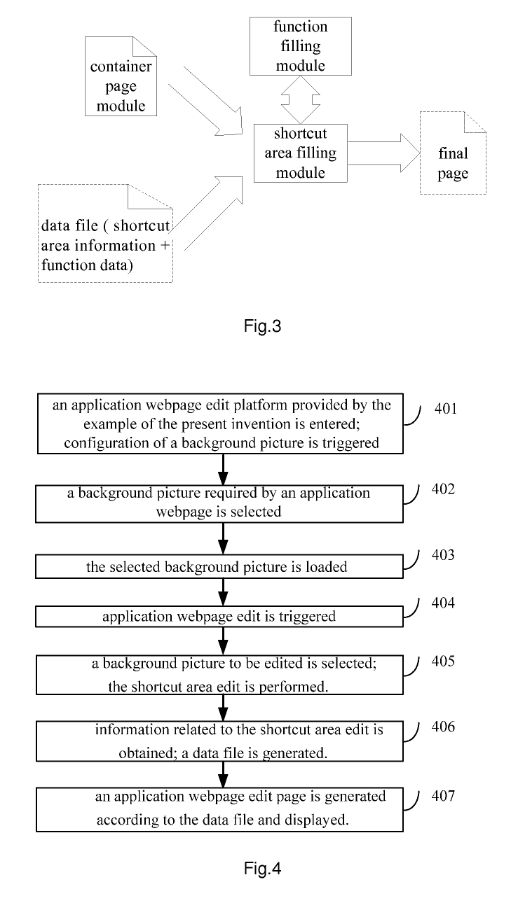

In practice, the structure among the function filling module, the shortcut area filling module and the container page module included in the page content parsing unit may also be shown in FIG. 3.

FIG. 3 is a schematic diagram illustrating another structure of a page content parsing unit in accordance with an example of the present invention. As shown in FIG. 3, the shortcut area filling module is connected with the function filling module and the container page module respectively, and receives the data file from the page content editing unit to ultimately form the application webpage.

A detailed example is taken as an example to further describe the method for editing an application webpage in accordance with examples of the present invention.

FIG. 4 is a detailed flowchart illustrating a method for editing an application webpage in accordance with an example of the present invention. As shown in FIG. 4, the method may include operations as follows.

In block 401, an application webpage edit platform provided by the example of the present invention is entered; configuration of a background picture is triggered.

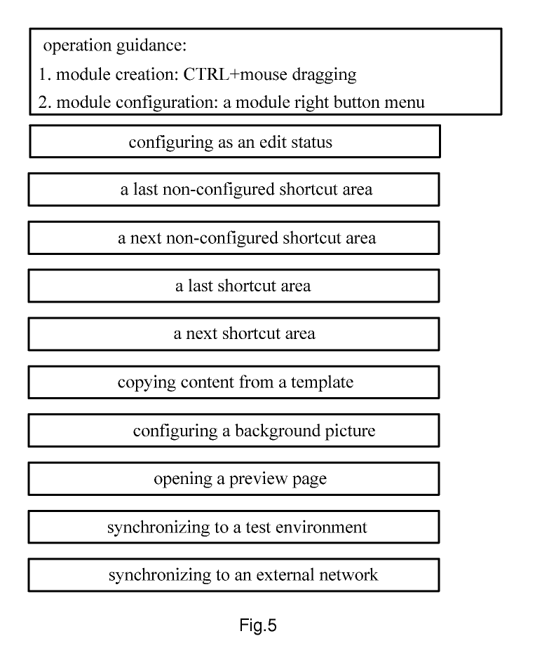

FIG. 5 is a schematic diagram illustrating an interface of an application webpage edit platform in accordance with an example of the present invention. As shown in FIG. 5, the interface includes an operation menu, which includes options like operation guidance, configuring as an edit status, a last non-configured shortcut area, a next non-configured shortcut area, a last shortcut area, a next shortcut area, copying content from a template, configuring a background picture, opening a preview page, synchronizing to a test environment, synchronizing to an external network, etc., which are displayed as control buttons. The operation guidance includes two steps of: 1. module creation: CTRL+mouse dragging; 2. module configuration: a module right button menu.

In block 402, a background picture required by an application webpage is selected.

In the block, an interface for selecting the background picture in accordance with the example of the present invention is entered through clicking the option of configuring a background picture shown in FIG. 5. In practice, the operation menu shown in FIG. 5 may alternatively be displayed as a column in the interface. An application ID, an application description and a background picture of a subject may be configured in the interface. The configured application ID may be fashion_vm_wlj2; the configured application description is the wlj2-th edition of a red diamond special issue; the background picture may be added by clicking an adding picture button, and a prepared background picture may be uploaded to the current interface by the adding picture button so as to facilitate the configuration of the shortcut area in the background picture.

After the background picture is uploaded, the interface is divided according to the number of the uploaded background pictures and is displayed as a list. Size of the list is determined according to the number of the background pictures and the number of operations performed to the background pictures. For example, the number of the uploaded background pictures is five, and then the current interface is divided into a 6*5 table. Five columns in the first row respectively are an index column, an operation column, a picture (background picture) column, a picture link column and a modification column. Five rows in the first column respectively are index numbers corresponding to the background pictures, e.g., the index numbers corresponding to the five background pictures respectively are 0˜4. Each uploaded picture is inserted into a corresponding picture column. The operation column includes operation options such as deletion, moving-up, moving-down, etc., which are displayed as control buttons. For example, if a user clicks a deletion control button, a picture in the picture column of the row is deleted. Link information of the background picture is displayed in the picture link column. The modification column includes a re-uploading option, which is also displayed as a control button. When a background picture in a row is changed through re-uploading, link information in the picture link column is changed accordingly.

After a background picture is inserted, a new background picture is added through the adding picture control button at the top of the interface. After the background picture adjustment is completed, a returning to template edit control button at the top of the interface is clicked to enter a next process.

In block 403, the selected background picture is loaded.

In the block, after the returning to template edit control button in the current interface is clicked, it goes back to the interface shown in FIG. 5. The difference between FIG. 5 is that the interface further includes the loaded background picture, i.e., the background picture of which the adjustment is completed is displayed.

In block 404, application webpage edit is triggered.

In the block, when the user clicks a configuring as an edit status control button in FIG. 5, the application webpage edit is triggered. The interface may pop up prompt information that the edit status has been configured, and all of modifications performed by the user are saved in a server in real time and will not be cancelled.

In block 405, a background picture to be edited is selected; the shortcut area edit is performed.

In the block, a background picture area to be edited is selected (a shortcut area is selected) according to the operation guidance. The application webpage edit platform automatically calculates the size of the selected shortcut area and the position information corresponding to the selected shortcut area. A right mouse button is clicked to pop up a shortcut area menu, which includes control buttons such as edit, copy, delete, configure coordinate, etc. In the example of the present invention, the edit control button is selected, the application webpage edit platform reads preconfigured function information from stored information, and a second interface for shortcut area edit is entered.

In a type control button popped up in the second interface for shortcut area edit, a needed function is selected from a drop-down menu corresponding to the type control button. The drop-down menu may include purchasing a whole set, trying-on a whole set, gifting a whole set, asking for a boutique library, details of a boutique library, etc. In the example of the present invention, details of a boutique library is selected, a details of a boutique library control button is clicked, the application webpage edit platform is triggered to search the stored information for configuration data corresponding to details of a boutique library. A third interface for shortcut area edit is entered.

In the third interface for shortcut area edit, the application webpage edit platform search, according to information about details of a boutique library selected by the user, the stored information for the configuration data corresponding to the details of a boutique library function to configure function data. In practice, the configuration data corresponding to the function may not be configured, but is directly taken as the function data, for example, a webpage application belonging to a link class may be implemented through configuring a link address by the user, alternately, may be implemented by preconfiguring the link address in the configuration data.

In block 406, information related to the shortcut area edit is obtained; a data file is generated.

In the block, after the edit of all of the shortcut areas is completed, the size, the position information and the function data of each edited shortcut area is obtained; a synchronizing to a test environment control button is clicked; the application webpage edit platform is triggered to call a related program to generate the data file, i.e., the size, the position information and the function data of the shortcut area is encapsulated into the data file supported by a webpage browser.

After the data file is generated successfully, synchronization success information is popped up for prompting a next operation.

In block 407, an application webpage edit page is generated according to the data file and displayed.

In the block, after the data file is generated successfully, a subject may be previewed, i.e., an opening a preview page control button is clicked; after an interface shown by the opening a preview page control button is opened, a prompt “click here for details” is shown to the user when a mouse resides in a shortcut area configured in the picture; the user clicks the shortcut area configured in the picture to enter a details page of a link corresponding to the shortcut area, the details page is switched to. The user may perform corresponding operations and function verification in the details page; after the function verification is succeed, information about the generated application webpage may be synchronized to a formal environment through clicking a synchronizing to an external network control button. Once it is synchronized to the formal environment, release of the whole subject is completed.

So far, the process is completed.

The above are just several examples of the present invention, and are not used for limiting the protection scope of the present invention. Any modifications, equivalents, improvements, etc., made under the spirit and principle of the present invention, are all included in the protection scope of the present invention.

1. A method for editing an application webpage, comprising:
prestoring information of a function and configuration data corresponding to the function;
generating a webpage design, monitoring that shortcut area edit is triggered, obtaining shortcut area information inputted by a user, obtaining size of a shortcut area and position information corresponding to the shortcut area according to the shortcut area information;
receiving function data inputted by the user according to the prestored configuration data, encapsulating the function data, the size of the shortcut area and the position information corresponding to the shortcut area into a data file;
loading a running environment of the data file, creating the shortcut area according to the size of the shortcut area and the position information corresponding to the shortcut area included in the data file; and
extracting the function data in the data file, generating page function codes corresponding to the function, filling the shortcut area corresponding to the function with the page function codes to form an application webpage for displaying.

2. The method of claim 1, wherein the function comprises gifting function and a video playing function.

3. The method of claim 2, wherein configuration data corresponding to the gifting function comprises configuring information about an ID of a gifted article, configuration data corresponding to the video playing function comprises configuring information about a video ID, and/or information about whether to play automatically, and/or information about a Uniform Resource Locator (URL) of a video cover picture.

4. The method of claim 1, further comprising:
when it is monitored that a user mouse resides in the shortcut area created in the application webpage, triggering the function corresponding to the shortcut area.

5. An apparatus for editing an application webpage, comprising a page content editing unit and a page content parsing unit, wherein,
the page content editing unit is to, after a webpage design is generated and it is monitored that shortcut area edit is triggered, obtain shortcut area information inputted by a user, calculate a first size of a shortcut area and a first position information corresponding to the shortcut area according to the shortcut area information; receive function data inputted by the user according to preconfigured configuration data corresponding to a function; encapsulate the function data, the first size of the shortcut area and the first position information corresponding to the shortcut area into a data file; and output to the page content parsing unit the data file; and
the page content parsing unit is to receive the data file, load a running environment of the data file, create the shortcut area according to the first size of the shortcut area and the first position information corresponding to the shortcut area included in the data file, extract the function data in the data file, generate page function codes corresponding to the function, fill the shortcut area corresponding to the function with the page function codes to form an application webpage for displaying.

6. The apparatus of claim 5, wherein the page content editing unit comprises a function editing module, a shortcut area editing module, a shortcut area displaying module, an encapsulation processing module and a storing module, wherein,
the function editing module is to prestore information of the function and the preconfigured configuration data corresponding to the function, receive a trigger signal outputted by the shortcut area editing module, and output to the shortcut area displaying module the stored information of the function and the stored configuration data corresponding to the function;
the shortcut area editing module is to, after the shortcut area edit is triggered, monitor the shortcut area information inputted by the user, calculate the first size of the shortcut area and the first position information corresponding to the shortcut area according to the shortcut area information, output the trigger signal to the function editing module, receive the function data outputted by the shortcut area displaying module, and output to the storing module the function data, the first size of the shortcut area and the first position information corresponding to the shortcut area;
the shortcut area displaying module is to receive the information of the function outputted by the function editing module to show to the user, receive the function data inputted by the user according to the configuration data corresponding to the function, and output to the shortcut area editing module the function data;
the storing module is to receive information outputted by the shortcut area editing module for storage; and
the encapsulation processing module is to encapsulate the information stored in the storing module into the data file, and output the data file to the page content parsing unit.

7. The apparatus of claim 6, wherein the shortcut area editing module is further to output to the shortcut area displaying module the first size of the shortcut area and the first position information corresponding to the shortcut area, receive a second size of the shortcut area and a second position information corresponding to the shortcut area returned from the shortcut area displaying module, output to the storing module the second size of the shortcut area and the second position information corresponding to the shortcut area to update the first size of the shortcut area and the first position information corresponding to the shortcut area; and
the shortcut area editing module is further to display the first size of the shortcut area and the first position information corresponding to the shortcut area to show to the user, and output to the shortcut area editing module the second size of the shortcut area and the second position information corresponding to the shortcut area which is ultimately determined by the user.

8. The apparatus of claim 5, wherein the page content parsing unit comprises a function filling module, a shortcut area filling module and a container page module, wherein,
the container page module is to receive the data file and load the running environment of the data file;
the function filling module is to receive the data file, extract the function data from the data file, generate the page function codes corresponding to the function, and output to the shortcut area filling module the page function codes; and
the shortcut area filling module is to create the shortcut area according to the first size of the shortcut area and the first position information corresponding to the shortcut area included in the data file, fill the shortcut area corresponding to the function with the page function codes outputted by the function filling module to form the application webpage.
